(19) United States
(12) Patent Application Publication
(10) Pub. No.: US 2002/0083453 A1
(43) Pub. Date: Jun. 27, 2002

(54) System and method for selecting language of on-screen displays and audio programs

(76) Inventor: Benoit Pol Menez, Carmel, IN (US)

Correspondence Address: Joseph S. Tripoli, THOMSON multimedia Licensing Inc., Patent Operations, P.O. Box 5312,, Two Independence Way, Princeton, NJ, 08543-5312, US

(21) Appl. No.: 09/748,951

(22) Filed: Dec. 27, 2000

(51) Int. Cl. H04N 7/18; G06F 3/00; H04N 5/445; G06F 13/00; H04N 9/47; H04N 7/084

(52) U.S. Cl. 725/47; 348/61; 725/137; 348/481; 348/462

(57) ABSTRACT

A system and method by which a user can select the language in which on-screen displays are displayed and audio programs are broadcast on a receiver by making a single-on-screen selection. The on-screen displays may include user menu, close captioning and/or teletext.

### FIELD OF THE INVENTION

The subject invention concerns television receivers or the like, and more particularly an apparatus and method for selecting the language of on-screen displays, and audio broadcasts of such receivers. The on-screen displays may include close captioning and teletext if the features are available.

### BACKGROUND OF THE INVENTION

Television receivers such as satellite television receivers manufactured by Thomson Consumer Electronics, Inc. Indianapolis, Ind. are typically programmed using on-screen displays. Such displays are typically comprised of a series of menus from which a user can select/deselect the receivers' available features such as the language in which the on-screen displays are displayed, the audio language in which programs are broadcast, whether to display on-screen the number of a channel being viewed, etc. A user typically selects such feature individually, one-by-one, by moving an on-screen cursor via operation of, for example, up, down, right, and left direction control keys, on a remote control device.

### SUMMARY OF THE INVENTION

The present inventor recognizes that for the current system if a user wants all of the on-screen displays for a television receiver to be displayed in a particular language, e.g., French, wants all audio programs viewed on that receiver to be broadcast in French, or wants the closed-captioning of all programs to be in French, the user must navigate through all of the different on-screen menus for the features the user seeks to activate and select French for each separate feature. Not only is this inconvenient, but if a receiver has many available features for which a language can be selected, doing so can be time consuming. Accordingly, it is an object of the preset invention to provide a system and method by which a user can select the language in which the on-screen displays and audio programs received on a digital receiver by means of a single selection, if the selected language is being broadcast. In another exemplary embodiment, the single selection may also select the language of the close captioning and teletext, if the futures and the selected language are available.

A system and method by which a user can make a single on-screen selection to simultaneously select the language which is used by on-screen displays and audio programs of a television receiver or the like.

### BRIEF DESCRIPTION OF THE DRAWING

FIG. 1 shows a plurality of menus from an on-screen display system for a conventional television receiver.

FIG. 2 shows an exemplary embodiment of an on-screen menu by which a single selection commands all menus to be displayed and all programs to be broadcast in one language according to the present invention.

FIG. 3 shows a flowchart depicting the operation the present invention.

FIG. 4 shows a block diagram of a satellite television system suitable for use with the invention.

### DETAILED DESCRIPTION OF THE INVENTION

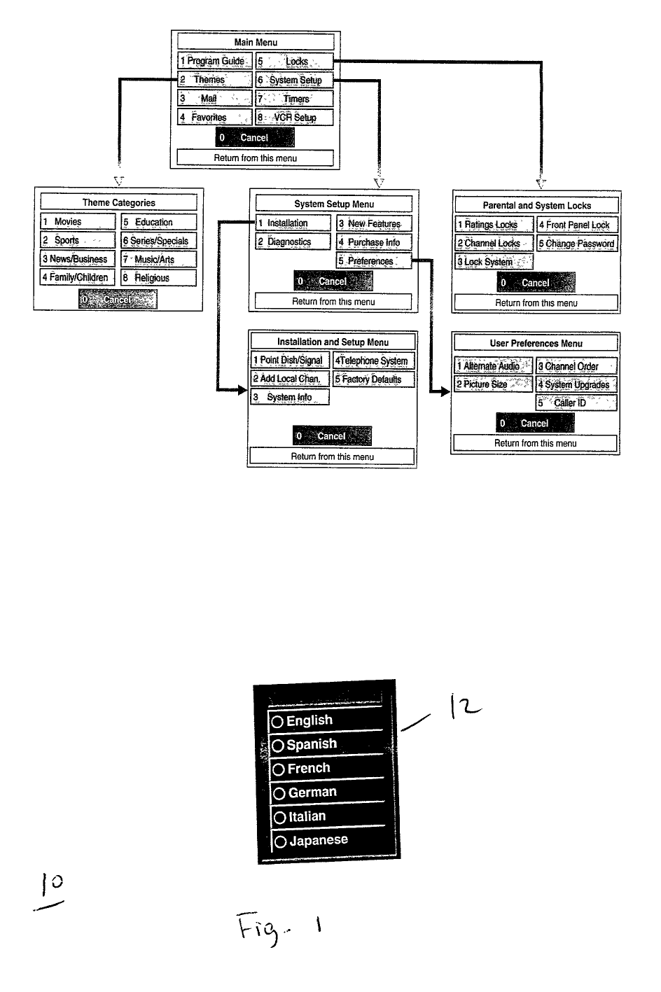

FIG. 1 shows a plurality of menus 10 from an on-screen display for an existing television receiver, including a menu 12 for selecting the language in which a particular feature is to be displayed. The on-screen display for the receiver requires that a user select the language in which a feature is to be displayed on-screen or broadcast by making a separate selection for each available feature.

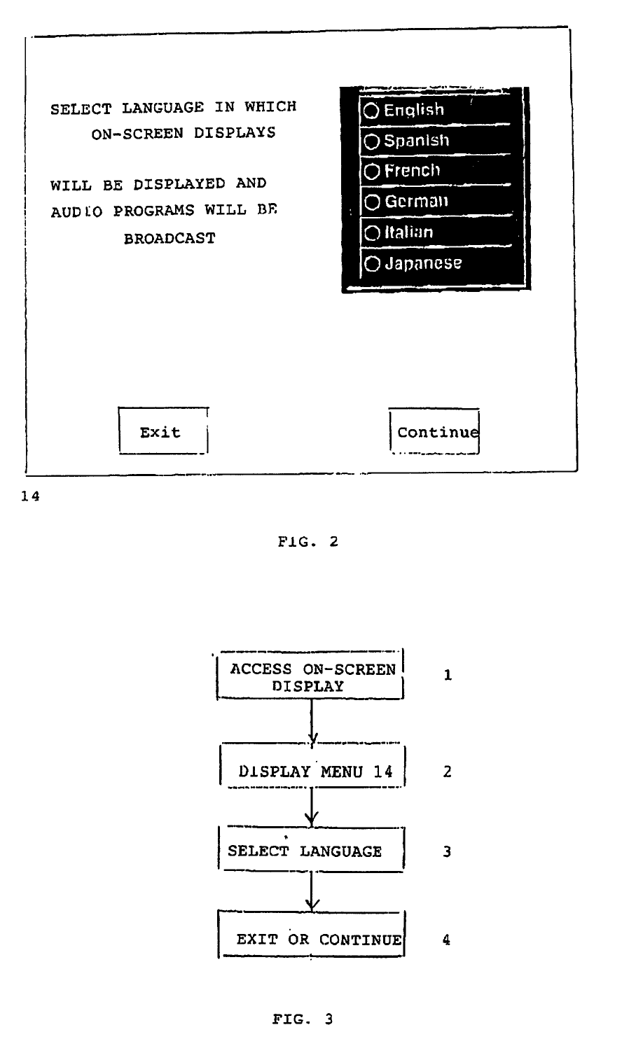

FIG. 2 shows an exemplary embodiment of an on-screen display according to the present invention, wherein menu 14 enables a user to select the language in which on-screen displays will be displayed and audio programs are broadcast by making a single selection rather than having to make separate language selections for each different feature. In addition, if closed captioning feature and the selected language are available for the television, then the language will also applied.

Menu 14 can be the first menu to appear on-screen when a user accesses the on-screen display for a receiver, either during the set-up operation when the receiver is used for the first time or when the on-screen display is accessed thereafter.

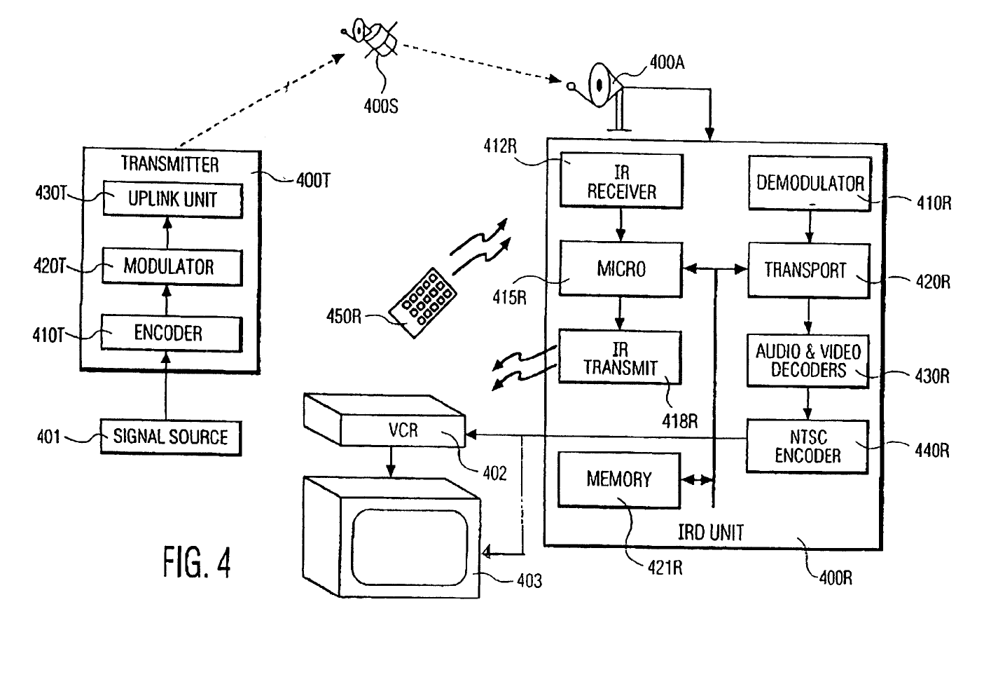

An exemplary hardware diagram of a system capable of implementing the present invention is shown in FIG. 4. The invention is employed and operated using a microprocessor, a microcontroller or a microcomputer, (see for example microprocessor 415R in FIG. 4) and a remote control device (see for example remote control unit 450R in FIG. 4). By bypassing menu 14, as described below, a user could of course select different languages for the on-screen displays, the closed-captioning and the audio broadcasts, or could select one language for two of these features and a second language for the third feature.

When receivers are fabricated, they are programmed with a “factory default” language, generally US-English in the USA. When a user powers up a receiver for the first time, the device recognizes that it is the first time it is being turned on and prompts the user to navigate through a series of set-up screens. Some of the setups relate to the language for features such as on-screen displays, closed-captioning and audio broadcasts. In an alternative embodiment of the present invention, a user could modify the default language for all language features by selecting a language for one feature. For example, if the first language feature set-up screen the user encounters is for on-screen displays, by changing the default, e.g., from English to French, for said feature, the user also changes the defaults accordingly for all other language-related features, e.g., audio broadcasts.

FIG. 3 shows a flowchart depicting the operation of the present invention. At step 1, a user uses a remote control device to access the on-screen display of the present invention by pressing “Menu” on the remote control device. In response, at step 2, menu 14 is displayed on the receiver. At step 3, the user uses the control keys on the remote control device to select the language in which they want all on-screen displays to be displayed and all audio programs broadcast. At step 4, the user selects to either exit from menu 14 and save to memory the selection of the language selected by selecting the “Exit” command, or to bypass menu 14 and be taken to a main menu from which the user can select/deselect non-language related features by selecting the “Continue” command. The order and number of steps used to select the language in which on-screen displays are to be displayed and audio programs broadcast can obviously be varied.

As noted above, the system and method of the present invention may be employed in an exemplary television communication system. FIG. 4 shows a block diagram of a satellite television communication system in which, a satellite 400S receives a signal representing audio, video, or data information from an earth-based transmitter 400T. The satellite amplifies and rebroadcasts this signal to a plurality of receivers 400R, located at the residences of consumers, via transponders operating at specified frequencies and having given bandwidths. Such a system includes an uplink transmitting portion (earth to satellite), an earth-orbiting satellite receiving and transmitting unit, and a downlink portion (satellite to earth) including a receiver located at the user's residence.

In a such a satellite system, the information necessary to select a given television program is not fixedly-programmed into each receiver but rather is down-loaded from the satellite continually on each transponder. The television program selection information comprises a set of data known as a Master Program Guide (MPG), which relates television program titles, their start and end times, a virtual channel number to be displayed to the user, and information allocating virtual channels to transponder frequencies and to a position in the time-multiplexed data stream transmitted by a particular transponder. In such a system, it is not possible to tune any channel until the first master program guide is received from the satellite, because the receiver (IRD, or Integrated Receiver Decoder) literally does not know where any channel is located, in terms of frequency and position (i.e. data time slot) within the data stream of any transponder.

A master program guide is preferably transmitted on all transponders with the television program video and audio data, and is repeated periodically, for example, every 2 seconds. The master program guide, once received, is maintained in a memory unit in the receiver, and updated periodically, for example every 30 minutes. Retention of the master program guide allows instantaneous television program selection because the necessary selection data are always available. If the master program guide were to be discarded after using it to select a television program, then a delay of at least two seconds would be incurred while a new program guide was acquired, before any further television program selections could be performed.

Once the channel transponder carrying a desired television program is tuned, the data packets containing the audio and video information for that program can be selected from the data stream received from the transponder by examining the data packets for the proper SCID (Service Component Identifier) 12 bit code. If the SCID of the currently received data packet matches the SCID of the desired television program as listed in the program guide, then the data packet is routed to the proper data processing sections of the receiver. If the SCID of a particular packet does not match the SCID of the desired television program as listed in the program guide, then that data packet is discarded.

A brief description of system hardware, suitable for implementing the above-described invention, now follows. In FIG. 4, a transmitter 400T processes a data signal from a source 401 (e.g., a program signal source) and transmits it to a satellite 400S which receives and rebroadcasts the signal to a receiving antenna 400A which applies the signal to a receiver 400R. Transmitter 400T includes an encoder 410T, a modulator (i.e., modulator/forward error corrector (FEC)) 420T, and an uplink unit 430T. Encoder 410T compresses and encodes signals from source 401 according to a predetermined standard such as MPEG. MPEG is an international standard developed by the Moving Picture Expert Group of the International Standards Organization for coded representation of moving pictures and associated audio stored on digital storage medium. An encoded signal from unit 410T is supplied to modulator/Forward Error Corrector (FEC) 420T, which encodes the signal with error correction data, and Quaternary Phase Shift Key (QPSK) modulates the encoded signal onto a carrier.

Uplink unit 430T transmits the compressed and encoded signal to satellite 400S, which broadcasts the signal to a selected geographic reception area. The signal from satellite 400S is received by an antenna dish 400A coupled to an input of a so-called set-top receiver 400R (i.e., an interface device situated atop a television receiver). Receiver 400R includes a demodulator (demodulator/Forward Error Correction (FEC) decoder) 410R to demodulate the signal and to decode the error correction data, an IR receiver 412 for receiving IR remote control commands, a microprocessor 415R, which operates interactively with demodulator/FEC unit 410R, and a transport unit 420R to transport the signal to an appropriate decoder 430R within unit 400R depending on the content of the signal, i.e., audio or video information. An NTSC Encoder 440R encodes the decoded signal to a format suitable for use by signal processing circuits in a standard NTSC consumer VCR 402 and standard NTSC consumer television receiver 403. Microprocessor (or microcontroller, or microcomputer) 415R receives infrared (IR) control signals such as key presses SELECT, RATING as discussed above, from remote control unit 450R, and sends control information to VCR 402 via an IR link 418R. Microprocessor 415R also generates the on-screen display (OSD) signals needed for presenting the interactive or confirmation EPG display screen shown for example in FIGS. 1, 2A or 2B, to the user. Microprocessor 415R also receives and interprets cursor key X and Y information in order to control the highlighting and selection of user choices in the on-screen display screens. In addition, Microprocessor 415R executes the program subroutine as represented by flow chart of FIG. 3 to provide the features according to aspects of the present invention.

Although the present invention was described with reference to a satellite television system, it is equally applicable to ground based television broadcast systems, both digital and analog, a settop box receiver, a wireless telephone, a wireless personal assistant such as a Palm Pilot®, or on any type of wired or wireless device that enables digitally stored information to be viewed on a display device. Also, information displayed and viewed using the present invention can be printed, stored to other storage medium, and electronically mailed to third parties.

It will be understood that various changes in the details, materials, and arrangements of the parts which have been described and illustrated above in order to explain the nature of this invention may be made by those skilled in the art without departing from the principle and the scope of the invention as recited in the following claims.

What is claimed is:

1. A method for selecting the language in which on-screen displays are displayed and audio programs are broadcast on a receiver, comprising the steps of:
accessing an on-screen display for the receiver; and
selecting a language in which on-screen displays and audio programs are broadcast on the receiver by entering a single selection on the on-screen display.

2. The method of claim 1, further comprising the step of saving the selection of the language to a memory.

3. The method according to claim 1, wherein the on-screen displays including close captioning.

4. The method according to claim 1, wherein the on-screen displays including teletext.

5. The method according to claim 1, wherein a remote control device and a microprocessor are used to select the language.

6. An apparatus for selecting language in which on-screen displays and audio programs are broadcast on a receiver, comprising:
means for displaying an on-screen display for the receiver; and
means for selecting a language in which on-screen displays are displayed and audio programs are broadcast on the digital receiver by entering a single selection on the on-screen display.

7. The apparatus according to claim 6, further comprising means for saving the selection of the language to a memory.

8. The apparatus according to claim 7, wherein the single selection selects the language in which all selectable display and audio features of the digital receiver are displayed and broadcast even if certain ones of said display and audio features are not selected by a user.

9. The apparatus according to claim 8, wherein the means includes a microcontroller and a remote control device.

10. The apparatus according to claim 8, wherein the on-screen displays including close captioning.

11. The apparatus according to claim 8, wherein the on-screen displays including teletext.
